(19) United States
(12) Patent Application Publication
(10) Pub. No.: US 2025/0238524 A1
(43) Pub. Date: Jul. 24, 2025

(54) BACKDOOR DETECTING APPARATUS, BACKDOOR DETECTING METHOD, AND BACKDOOR DETECTING PROGRAM

(71) Applicant: NEC Corporation, Minato-ku, Tokyo (JP)

(72) Inventors: Nakul GHATE, Tokyo (JP); Yusuke Shimada, Tokyo (JP); Kohei Tatara, Tokyo (JP)

(73) Assignee: NEC Corporation, Minato-ku, Tokyo (JP)

(21) Appl. No.: 18/698,063

(22) PCT Filed: Oct. 14, 2021
(86) PCT No.: PCT/JP2021/038007

§ 371 Date: Apr. 3, 2024

(51) Int. Cl. G06F 21/57

(52) U.S. Cl. CPC G06F 21/577; G06F 2221/033

(57) ABSTRACT

A backdoor detecting apparatus includes a detecting part that detects a source and a sink from a control flow graph of a program, wherein the source is a function which accepts external input, and the sink is a predetermined function regarded as impacting on a machine; an extracting part that extracts Function-Operation Flow from the control flow graph, wherein the Function-Operation Flow is an execution path from the source leading to the sink; and a prioritizing part that prioritizes the Function-Operation Flow based on a level of threat.

### TECHNICAL FIELD

The present invention relates to a backdoor detecting apparatus, backdoor detecting method, and backdoor detecting program.

### BACKGROUND ART

The importance to detect backdoor functions have increased to mitigate the risk of damage to enterprise resources and information. Today, computer systems are becoming more and more complex, and it is difficult to build them using the products of a single company. Therefore, it is common to obtain products from external sources and assemble the obtained products to build a system. In this supply chain, the manufacturers are to be responsible. This is because backdoor detection is becoming important.

However, detecting backdoors in firmware without source code requires a lot of time and effort, because backdoor detection in firmware requires disassembly and de-compilation of firmware, detailed analysis of suspicious functions and execution paths, and manual screening of backdoors. Therefore, there is a need for computer-aided techniques in the tasks associated with backdoor detection (See PLT 1 for example).

### CITATION LIST

### Patent Literature

[PLT 1] International Publication Number WO2021/028989A1

### SUMMARY OF INVENTION

### Technical Problem

The disclosures of the above prior art document shall be incorporated by reference into this document. The following analysis has been made by the inventors.

Even in the conventional technology, it is possible to find the functions that should be analyzed with caution and the execution paths that call them, which are often used for backdoors. However, regardless of the existence of backdoors, the execution path often contains such functions, which define library functions or system calls. Finally, it is necessary for an operator to analyze manually the execution paths.

In view of the above problems, it is an object of the present invention to provide a backdoor detecting apparatus, backdoor detecting method, and backdoor detecting program that contribute to minimize cost in terms of time and efforts of security operator.

### Solution to Problem

According to a first aspect of the present invention, there is provided a backdoor detecting apparatus comprising a detecting part that detects a source and a sink from a control flow graph of a program, wherein the source is a function which accepts external input and the sink is a predetermined function regarded as impacting on a machine: an extracting part that extracts Function-Operation Flow from the control flow graph, wherein the Function-Operation Flow is an execution path from the source leading to the sink: and a prioritizing part that prioritizes the Function-Operation Flow based on a level of threat.

According to a second aspect of the present invention, there is provided a backdoor detecting method comprising detecting a source and a sink from a control flow graph of a program, wherein the source is a function which accepts external input and the sink is a predetermined function regarded as impacting on a machine: extracting Function-Operation Flow from the control flow graph, wherein the Function-Operation Flow is an execution path from the source leading to the sink: and prioritizing the Function-Operation Flow based on a level of threat.

According to a third aspect of the present invention, there is provided a backdoor detecting program comprising: a detecting process that detects a source and a sink from a control flow graph of a program, wherein the source is a function which accepts external input and the sink is a predetermined function regarded as impacting on a machine: an extracting process that extracts Function-Operation Flow from the control flow graph, wherein the Function-Operation Flow is an execution path from the source leading to the sink: and a prioritizing process that prioritizes the Function-Operation Flow based on a level of threat. Further, this program can be stored in a computer-readable storage medium. The storage medium may be non-transient one such as a semiconductor memory, a hard disk, a magnetic recording medium, an optical recording medium, and the like. The present invention can also be realized as a computer program product.

### Advantageous Effects of Invention

According to each aspect of the present invention, there can be provided a backdoor detecting apparatus, backdoor detecting method, and backdoor detecting program that contribute to minimize cost in terms of time and efforts of security operator.

### BRIEF DESCRIPTION OF DRAWINGS

FIG. 1 is schematic diagram for explaining a backdoor detecting apparatus.

FIG. 2 is an example of the sub-call graphs which contains execution path from sources and sinks.

FIG. 3 is an example of the process for obtaining the Function-Operation Flow.

FIG. 4 is a flow chart that shows a schematic backdoor detecting method.

FIG. 5 is a drawing illustrating an example of the hardware configuration of the backdoor detecting apparatus.

### DESCRIPTION OF EMBODIMENTS

Example embodiments of the present invention will be described with reference to the drawings. However, the present invention is not limited to the example embodiments described below. Further, in each drawing, the same or corresponding elements are appropriately designated by the same reference signs. It should be noted that the drawings are schematic, and the dimensional relationships and the ratios between the elements may differ from the actual ones. There may also be parts where the dimensional relationships and the ratios between drawings are different.

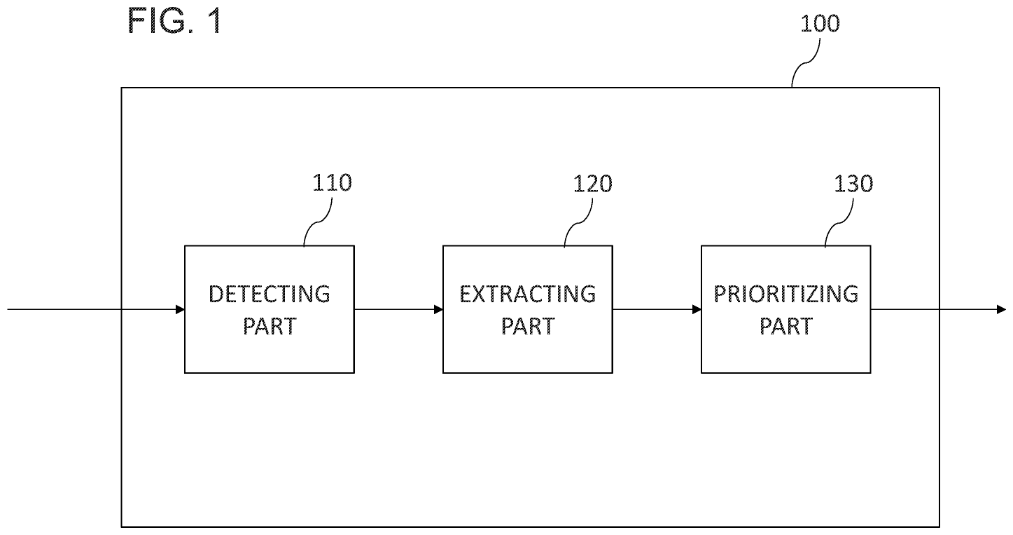

FIG. 1 is schematic diagram for explaining a backdoor detecting apparatus. As shown in FIG. 1, the backdoor detecting apparatus 100 comprising a detecting part 110, an extracting part 120, and a prioritizing part 130.

The detecting part 110 detects a source and a sink from a control flow graph of a program. The source is a function which accepts external input and the sink is a predetermined function regarded as impacting on a machine. There are functions inside the system which have more significant impacts in causing the malicious threats, such as system calls and library functions. We call them sinks. An attacker uses functions to get triggered with the external input to activate the backdoor and perform malicious operations. We call the functions which accept external inputs as sources.

The control flow graph of the program is a representation of all possible paths that the program may take when it is executed. In this graph, a node represents a sequential sequence of code that contains no branches and no destination, and a directed edge connecting a node to another node represents a jump target from one block to another. The control flow graph is obtained by usual static-analysis tools.

The extracting part 120 extracts Function-Operation Flow from the control flow graph. The Function-Operation Flow is an execution path from the source leading to the sink. As mentioned above, an attacker usually uses a source to trigger a sink for activating the backdoor and perform malicious operations. The extracting part 120 searches the execution path that an attacker might use.

The prioritizing part 130 prioritizes the Function-Operation Flow based on the level of threat. The prioritizing part 130 eliminates the need to perform a full binary search and makes the analysis more efficient.

The following is a detailed description of the processing performed by the detecting part 110, the extracting part 120, and the prioritizing part 130.

The detecting part 110 detects a source and a sink from a control flow graph of a program. In this process, the detecting part 110 may refer to the list of the sources (i.e., external input-receiving functions) and the list of the sinks (i.e., functions with significant impact on the system), and searches listed functions in the control flow graph of the program. The followings are examples of the list of the sources and the list of the sinks.

### LIST OF SOURCES

Function list: {scanf, fgets, read, vscanf, . . . }

### LIST OF SINKS

Function list: {write, execve, link, rename, . . . }

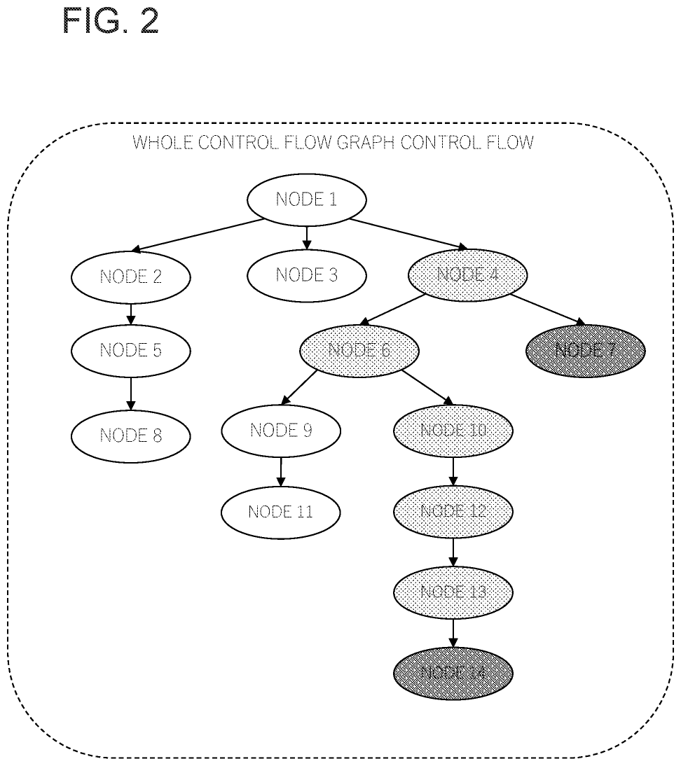

The extracting part 120 extracts Function-Operation Flow from the control flow graph. Firstly, the extracting part 120 detects a sub-call graph within the whole control flow graph which contains execution path from a source and a sink. This extremely narrows the search space. FIG. 2 shows an example of the sub-call graphs which contains execution path from sources and sinks. For example, when a source is contained in Node 7 and a sink is contained in Node 14, the sub-graph consists of Nodes 4, 6-7, 10-14.

Secondly, the extracting part 120 searches for the source to the sink within the identified sub-call graph. If the execution path is found, the extracting part 120 generates the Function-Operation Flow which contains instructions and data derived from external-input. If no execution path is found, or no function registered in the function table is found, report no backdoor.

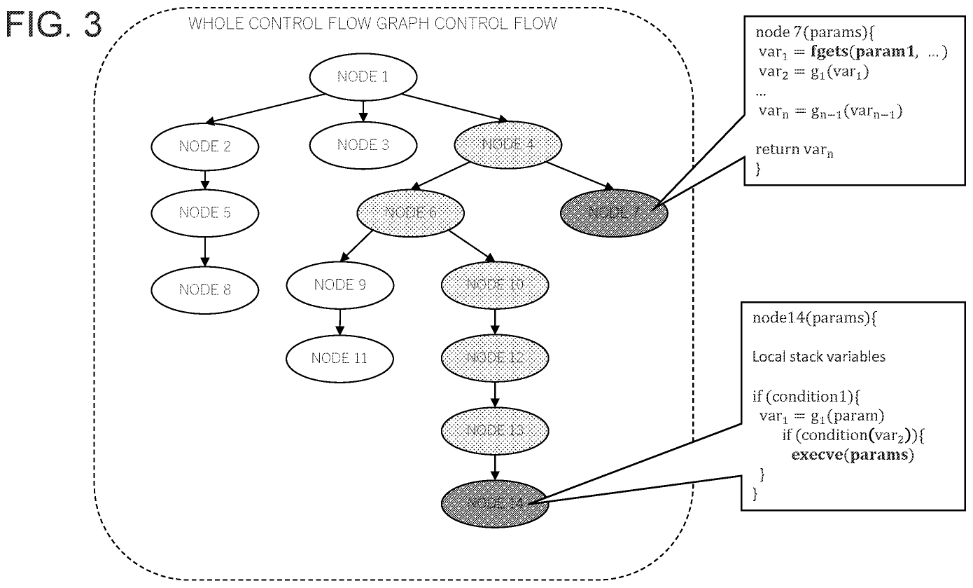

FIG. 3 shows an example of the process for obtaining the Function-Operation Flow. The example in FIG. 3 also supposes that a source is contained in Node 7 and a sink is contained in Node 14.

In steps to search for execution path from the source (fgets), the extracting part 120 creates variable-operation propagation chain within Node 7. If the return variable (varₙ) contained in the variable-operation propagation chain within Node 7, propagate the variable (varₙ) to the calling Node 4. The extracting part 120 continues repeating the above steps, until no return variable found and no propagation for the variable found.

In steps to search for execution path to the sink (execve), the extracting part 120 creates conditional branch propagation chain within Node 14. The sink (execve) is guarded by branch conditions. Next, the extracting part 120 checks whether the conditional branches are present in the variable-propagation chain from the above searching for execution path from the source steps. If a conditional branch is present in the variable-propagation chain, the execution path to the sink function is found.

The extracting part 120 continues searching for Function-Operation Flows for each of the sources and sinks. Then, extracting part 120 obtains the list of the Function-Operation Flows of the program to be analyzed. The Function-Operation Flow contains all the variables and instructions derived from the external-input receiving function call leading to the sink. The following is an example of the list of the Function-Operation Flow (FOF).

FOF = {
{func 7: (instruction1, data1), (instruction2, data2), ... }
{func 4: (instruction1, data1), (instruction2, data2), ... }
...
{func 14: (instruction1, data1), (instruction2, data2), ... }
}

The prioritizing part 130 prioritizes the Function-Operation Flows based on the level of threat. To prioritize them, the prioritizing part 130 has the following functions.

The prioritizing part 130 classifies the sinks based on the level of threat. Some sinks are more threatening than others which allows full control to the users. The following is an example of the list of the sinks classified by the level of threat, to which the prioritizing part 130 refers.

| Threat | | |
|---|---|---|
| Level | Description | Examples |
| 1 | Allows full control of | open, unlink, link, chmod, lchown, |
| | the system | rename |
| 2 | Used for a denial of | creat, umount, mkdir, rmdir, umount2, |
| | service attack | ioctl, nfsservctl |
| 3 | Used for subverting | read, write, close, chdir, lseek, dup, |
| | the invoking process | fcntl, umask |
| 4 | Harmless | oldstat, oldfstat, access, sync, pipe, |
| | | ustat, oldlstat |

For each sink function, the prioritizing part 130 prioritizes the Function-Operation Flows based on the number of external-input branch conditions inside them. The reason is that more external-input branch condition may contain potential backdoor information as the attacker always use complex branching routes to hide the actual flow of data. The following is an example of the number of external-input dependent branch conditions inside the Function-Operation Flows leading to the sink (open).

| | FOF prioritized with number of external-input |
|---|---|
| Sink name | dependent branch conditions |
| open | FOF #1: 15 |
| | FOF #2: 11 |
| | FOF #6: 4 |
| | FOF #9: 2 |

For each sink function, the prioritizing part 130 prioritizes the Function-Operation Flows based on the entropy of the data in each Function-Operation Flow. Higher entropy suggests the presence of encrypted and/or compressed data. Encrypted data has a very high potential to contain authentication bypassing passwords and thus exhibit backdoor functionalities.

The entropy calculation is given as follows.

E=−Σᵢpᵢlog₂pᵢ

Here, pᵢ is the probability for the occurrence of each byte count. To calculate the Function-Operation Flows, the Function-Operation Flows are parsed into the instructions (opcode) and data, which is converted to hexadecimal bytes. The following is an example of the instructions (opcode) and data in the Function-Operation Flow.

| FOF # | {Instruction: data} | {DATA: HEX} |
|---|---|---|
| 1 | { | { |
| | INT_ADD: DATA1; | DATA1: 14 00 af 29, . . . , |
| | INT_SUB: DATA2; | DATA2: 15 be 0c 1f, . . . , |
| | CALL: DATA3; | DATA3: 00 0131 45, . . . , |
| | CBRANCH: DATA4; | DATA4: 41 98 ce ad, . . . , |
| | . . . | . . . |
| | } | } |
| 2 | { | { |
| | PTR_ADD: DATA1; | DATA1: 14 00 af 29, . . . , |
| | CALLIND: DATA2; | DATA2: 15 be 0c 1f, . . . , |
| | CBRANCH: DATA3; | DATA3: 00 0131 45, . . . , |
| | CBRANCH: DATA4; | DATA4: 41 98 ce ad, . . . , |
| | . . . | . . . |
| | } | } |

The values of the bytes will be 0 to 256, hence index ‘i’ will range from 0 to 256 and the entropy values will be between 0 and 8. The probability for the occurrence of each byte count is calculated by the formula pᵢ=nᵢ/n_{TOTAL}. For example, when index i=4, nᵢ=25, n_{TOTAL}=15000, the probability for the occurrence of each byte count p₄=25/15000.

The backdoor detecting apparatus 100 reports the prioritized Function-Operation Flow to the security operator. In this phase, the backdoor detecting apparatus 100 is favorable to comprising a database that contains known backdoor and an assessment part that compares the prioritized Function-Operation Flow with the known backdoor database.

As above, the backdoor detecting apparatus 100 comprises a detecting part 110 that detects a source and a sink from a control flow graph of a program, an extracting part 120 that extracts Function-Operation Flow from the control flow graph, and a prioritizing part 130 that prioritizes the Function-Operation Flow based on the level of threat, and then contributes to minimize cost in terms of time and efforts of security operator.

### BACKDOOR DETECTING METHOD)

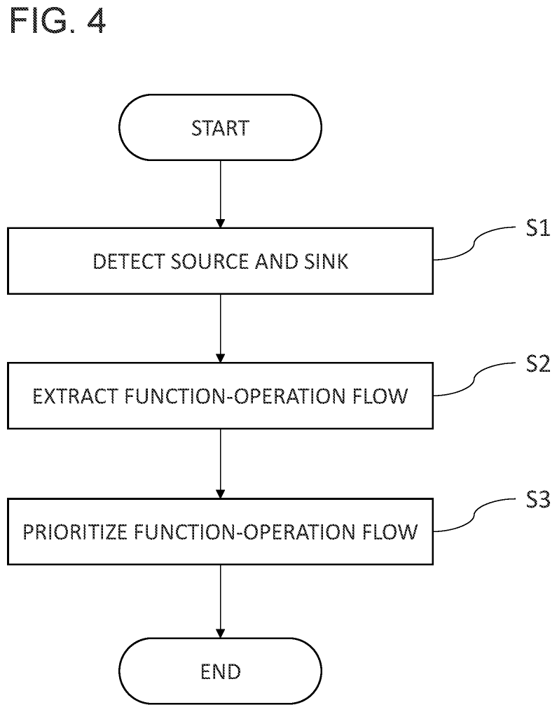

FIG. 4 is a flow chart that shows a schematic backdoor detecting method. As shown in FIG. 4, the backdoor detecting method comprise detecting step (S1), extracting step (S2), and prioritizing step (S3).

In detecting step (S1), a source and a sink are detected from a control flow graph of a program. As already described, the source is a function which accepts external input and the sink is a predetermined function regarded as impacting on a machine.

In extracting step (S2), a Function-Operation Flow is extracted from the control flow graph. Here, the Function-Operation Flow is an execution path from the source leading to the sink.

In prioritizing step (S3), the Function-Operation Flow is prioritized based on the level of threat. In this prioritizing, the sinks classified based on the level of threat, and/or the Function-Operation Flows are ordered by the number of external-input branch conditions inside them and/or the Function-Operation Flows are prioritized based on the entropy of the data in each Function-Operation Flow.

As above, the backdoor detecting method comprises detecting step (S1), extracting step (S2), and prioritizing step (S3), and then contributes to minimize cost in terms of time and efforts of security operator.

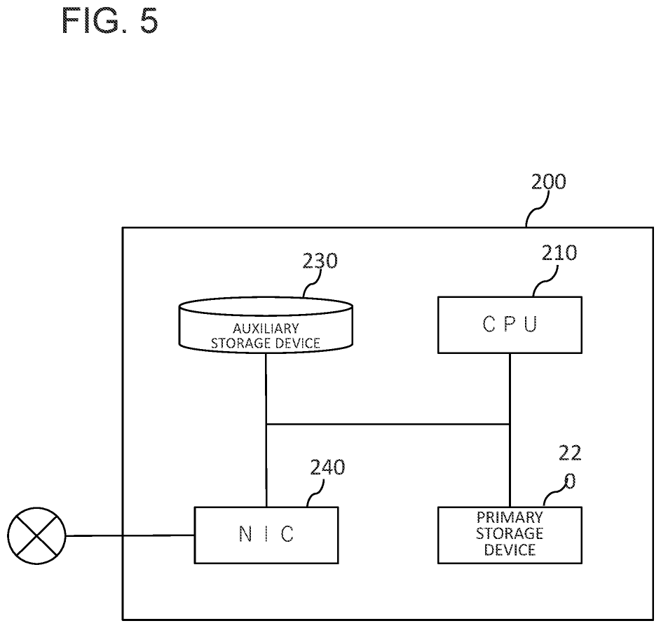

FIG. 5 is a drawing illustrating an example of the hardware configuration of the backdoor detecting apparatus. The backdoor detecting apparatus 100 described above may be configured as an information processing apparatus (computer) 200 having the hardware configuration shown in FIG. 5. It should be noted that the hardware configuration shown in FIG. 5 is merely an example of the hardware configuration realizing the function of the backdoor detecting apparatus 100 and is not intended to limit the hardware configuration of the backdoor detecting apparatus 100. The detecting apparatus 100 may include hardware not shown in FIG. 5.

As shown in FIG. 5, the computer 200 comprises a CPU (Central Processing Unit) 210, a primary storage device 220, an auxiliary storage device 230, and a NIC (Network Interface Card) 240, which is a communication interface. These elements are connected to each other by, for instance, an internal bus.

The CPU 210 executes the backdoor detecting program. The primary storage device 220 is, for instance, a RAM (Random Access Memory) and temporarily stores the backdoor detecting program executed by the computer 200 so that the CPU 210 can process it.

The auxiliary storage device 230 is, for instance, an HDD (Hard Disk Drive) and may store the backdoor detecting program in the medium to long term. The backdoor detecting program may be provided as a computer program stored in a non-transitory computer-readable storage medium. The auxiliary storage device 230 can be used to store the backdoor detecting program stored in a non-transitory computer-readable storage medium over the medium to long term.

The NIC 240 provides an interface to an external terminal via a network. The NIC 240 is used to receive an image of the surface pattern of an end of the cable to be connected and images of the host name and a port of an apparatus or to transmit the work support information based on the result of individual product identification.

When the computer 200 as described above executes the backdoor detecting program, the computer 200 acts as the backdoor detecting apparatus 100 and implements the backdoor detecting method shown in FIG. 4.

The above example embodiments may partially or entirely be described, but not limited to, as the following notes.

### (Note 1)

A backdoor detecting apparatus comprising: a detecting part that detects a source and a sink from a control flow graph of a program, wherein the source is a function which accepts external input, and the sink is a predetermined function regarded as impacting on a machine: an extracting part that extracts Function-Operation Flow from the control flow graph, wherein the Function-Operation Flow is an execution path from the source leading to the sink: and a prioritizing part that prioritizes the Function-Operation Flow based on a level of threat.

### (Note 2)

The backdoor detecting apparatus according to Note 1, wherein the prioritizing part that prioritizes the Function-Operation Flow based on an external-input dependent conditional branch(s) in the Function-Operation Flow.

### (Note 3)

The backdoor detecting apparatus according to Note 2, wherein the prioritizing part that prioritizes the Function-Operation Flow based on the number of the external-input dependent conditional branch.

### (Note 4)

The backdoor detecting apparatus according to Note 1, wherein the prioritizing part that prioritizes the Function-Operation Flow based on data in the Function-Operation Flow.

### (Note 5)

The backdoor detecting apparatus according to Note 4, wherein the prioritizing part that prioritizes the Function-Operation Flow based on entropy of the data.

### (Note 6)

The backdoor detecting apparatus according to any one of Notes 1 to5, further comprising: a database that contains known backdoor; and an assessment part that compares the prioritized Function-Operation Flow with the known backdoor database.

### (Note 7)

The backdoor detecting apparatus according to any one of Notes 1 to 6, wherein the Function-Operation Flow contains all the variables and instructions derived from the external-input receiving function call leading to the sink.

### (Note 8)

The backdoor detecting apparatus according to any one of Notes 1 to 7, further comprising: a list of the sinks classified by the level of threat to be referred by the prioritizing part.

### (Note 9)

A backdoor detecting method comprising: detecting a source and a sink from a control flow graph of a program, wherein the source is a function which accepts external input and the sink is a predetermined function regarded as impacting on a machine: extracting Function-Operation Flow from the control flow graph, wherein the Function-Operation Flow is an execution path from the source leading to the sink: and prioritizing the Function-Operation Flow based on a level of threat.

### (Note 10)

A backdoor detecting program comprising: a detecting process that detects a source and a sink from a control flow graph of a program, wherein the source is a function which accepts external input and the sink is a predetermined function regarded as impacting on a machine: an extracting process that extracts Function-Operation Flow from the control flow graph, wherein the Function-Operation Flow is an execution path from the source leading to the sink: and a prioritizing process that prioritizes the Function-Operation Flow based on a level of threat.

While each example embodiment of the present invention has been described, it is to be noted that it is possible to modify or adjust the example embodiments or examples within the whole disclosure of the present invention (including the Claims) and based on the basic technical concept thereof. Further, it is possible to variously combine or select (or at least partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. Further, the disclosure of Patent Literature cited above is incorporated herein in its entirety by reference thereto.

### REFERENCE SIGNS LIST

100 backdoor detecting apparatus
110 detecting part
120 extracting part
130 prioritizing part
200 information processing apparatus (computer)
210 CPU (Central Processing Unit)
220 primary storage device
230 auxiliary storage device
240 NIC (Network Interface Card)

What is claimed is:

1. A backdoor detecting apparatus, comprising:
a detecting part that detects a source and a sink from a control flow graph of a program, wherein the source is a function which accepts external input, and the sink is a predetermined function regarded as impacting on a machine;
an extracting part that extracts Function-Operation Flow from the control flow graph, wherein the Function-Operation Flow is an execution path from the source leading to the sink; and
a prioritizing part that prioritizes the Function-Operation Flow based on a level of threat.

2. The backdoor detecting apparatus according to claim 1, wherein the prioritizing part that prioritizes the Function-Operation Flow based on an external-input dependent conditional branch(es) in the Function-Operation Flow.

3. The backdoor detecting apparatus according to claim 2, wherein the prioritizing part that prioritizes the Function-Operation Flow based on the number of the external-input dependent conditional branch.

4. The backdoor detecting apparatus according to claim 1, wherein the prioritizing part that prioritizes the Function-Operation Flow based on data in the Function-Operation Flow.

5. The backdoor detecting apparatus according to claim 4, wherein the prioritizing part that prioritizes the Function-Operation Flow based on entropy of the data.

6. The backdoor detecting apparatus according to claim 1, further comprising:
a database that contains known backdoor; and
an assessment part that compares the prioritized Function-Operation Flow with known backdoor database.

7. The backdoor detecting apparatus according to claim 1, wherein the Function-Operation Flow contains all the variables and instructions derived from the external-input receiving function call leading to the sink.

8. The backdoor detecting apparatus according to claim 1, further comprising:
a list of the sinks classified by the level of threat to be referred by the prioritizing part.

9. A backdoor detecting method comprising:
detecting a source and a sink from a control flow graph of a program, wherein the source is a function which accepts external input and the sink is a predetermined function regarded as impacting on a machine;
extracting Function-Operation Flow from the control flow graph, wherein the Function-Operation Flow is an execution path from the source leading to the sink; and
prioritizing the Function-Operation Flow based on a level of threat.

10. A non-transitory computer readable medium storing a backdoor detecting program comprising:
a detecting process that detects a source and a sink from a control flow graph of a program, wherein the source is a function which accepts external input and the sink is a predetermined function regarded as impacting on a machine;
an extracting process that extracts Function-Operation Flow from the control flow graph, wherein the Function-Operation Flow is an execution path from the source leading to the sink; and
a prioritizing process that prioritizes the Function-Operation Flow based on a level of threat.

11. The backdoor detecting method according to claim 9, wherein the prioritizing the Function-Operation Flow based on an external-input dependent conditional branch(es) in the Function-Operation Flow.

12. The backdoor detecting method according to claim 11, wherein the prioritizing the Function-Operation Flow based on the number of the external-input dependent conditional branch.

13. The backdoor detecting method according to claim 9, wherein the prioritizing the Function-Operation Flow based on data in the Function-Operation Flow.

14. The backdoor detecting method according to claim 13, wherein the prioritizing the Function-Operation Flow based on entropy of the data.

15. The backdoor detecting method according to claim 9, further comprising:
comparing the prioritized Function-Operation Flow with known backdoor database.

16. The non-transitory computer readable medium storing the backdoor detecting program according to claim 10, wherein the prioritizing process that prioritizes the Function-Operation Flow based on an external-input dependent conditional branch(es) in the Function-Operation Flow.

17. The non-transitory computer readable medium storing the backdoor detecting program according to claim 16, wherein the prioritizing process that prioritizes the Function-Operation Flow based on the number of the external-input dependent conditional branch.

18. The non-transitory computer readable medium storing the backdoor detecting program according to claim 10, wherein the prioritizing process that prioritizes the Function-Operation Flow based on data in the Function-Operation Flow.

19. The non-transitory computer readable medium storing the backdoor detecting program according to claim 18, wherein the prioritizing process that prioritizes the Function-Operation Flow based on entropy of the data.

20. The non-transitory computer readable medium storing the backdoor detecting program according to claim 10, further comprising:
an assessment process that compares the prioritized Function-Operation Flow with known backdoor database.
